(19) United States
(12) Patent Application Publication
(10) Pub. No.: US 2022/0371058 A1
(43) Pub. Date: Nov. 24, 2022

(54) MOBILE WASTE SEGREGATION SYSTEM

(71) Applicant: The Green Block Consulting Group Ltd, Berkshire (GB)

(72) Inventors: Jack Williams, Berkshire (GB); Ross Walker, Brentwood (GB)

(21) Appl. No.: 17/599,266

(22) PCT Filed: Jan. 15, 2021
(86) PCT No.: PCT/GB2021/050095

§ 371 Date: Sep. 28, 2021

(30) Foreign Application Priority Data
Feb. 5, 2020 (GB) 2001546.7

(51) Int. Cl. B07C 7/04

(52) U.S. Cl. CPC B07C 7/04

(57) ABSTRACT

There is provided a mobile waste segregation system transportable between different sites. The mobile waste segregation system comprises: an enclosure unit (10) configured for housing a human operator (12), the enclosure unit (10) including a waste segregation facility (14) for receiving at least one waste container and segregating the waste from the or each waste container into different streams of product or commodity, the enclosure unit (10) further including a packing facility operable to pack each stream of product or commodity; an asset tag reader operable to read an asset tag of the or each waste container; and an asset tagging device operable to add an asset tag to each packed stream of product or commodity and/or update an existing asset tag of each packed stream of product or commodity.

This invention relates to a mobile waste segregation system.

Public spaces, especially spaces with a high number of people, tend to accumulate waste at a high rate. It is known to have waste bins to accommodate different types of waste such as unrecyclable waste, paper, plastic and aluminium cans.

According to a first aspect of the invention, there is provided a mobile waste segregation system transportable between different sites, the mobile waste segregation system comprising:

an enclosure unit configured for housing a human operator, the enclosure unit including a waste segregation facility for receiving at least one waste container and segregating the waste from the or each waste container into different streams of product or commodity, the enclosure unit further including a packing facility operable to pack each stream of product or commodity;

an asset tag reader operable to read an asset tag of the or each waste container; and

an asset tagging device operable to add an asset tag to each packed stream of product or commodity and/or update an existing asset tag of each packed stream of product or commodity.

The or each waste container may be, but is not limited to, a bag, a bin, a package or a box.

The configuration of the mobile waste segregation system of the invention enables a human operator to carry out a waste segregation process within an enclosed environment that not only efficiently segregates the waste into the different streams of product or commodity that can be collected and transported by other parties to their respective end destinations for further usage or processing but also integrates asset tracking procedures into the waste segregation process to generate accurate quantitative and qualitative waste data.

Depending on the information stored in the asset tags, the waste data enables the tracking of information in the form of, but not limited to, sources of the waste by waste-producing sites and by individual occupants of a given waste-producing site, the type and amount of waste generated and the type, amount and end destinations of the packed streams of product or commodity. The waste data provides valuable feedback that can be used to improve certain aspects of waste management systems of the waste-producing sites such as, but not limited to, improving recycling rates and quality, reducing cross-contamination, optimising waste collection frequency, optimising the number of waste containers required by a given waste-producing site, usage of waste containers, transparency on waste producers by waste type, quantity and source, and trackable carbon footprint and pollution figures. This in turn has the benefit of cost savings and better compliance with environmental regulations.

The transportable nature of the mobile waste segregation system in combination with the integrated asset tracking procedures of the waste segregation process not only enhances the generation of the waste data by enabling the waste segregation process to be carried out on-site at the waste-producing site, thus avoiding the problem of managing waste from multiple waste-producing sites, but also allows the asset tracking to be carried out on-site at the waste-producing site to provide the waste data with accurate time, date and location information.

The invention is particularly useful for sites with a high number of people, such as flat blocks, retail buildings, transportation hubs (such as airports and train stations) and hospitals. This is because these sites tend to produce high amounts of mixed waste that are collected in an on-site central facility, which makes it difficult to track the quantity and type of waste generated and the identities of the waste producers.

In contrast to the invention, waste is conventionally transported from different waste-producing sites to a central waste processing location. This not only increases air pollution and carbon footprint due to the increase in transportation distance and the need for heavy waste machinery to accommodate and process the waste from multiple waste-producing sites but also makes it difficult to obtain accurate waste data for different waste-producing sites, thus preventing optimisation of the waste management systems of the waste-producing sites. In comparison, the transportable nature of the mobile waste segregation system provides environmental benefits in the form of reduced overall transportation distance from waste source to waste end destination and reduces energy requirement and carbon footprint due to the use of a human operator to carry out the waste segregation process.

Optionally the asset tag reader may be, but is not limited to, a barcode reader or a radio-frequency identification (RFID) reader. Further optionally the asset tagging device may be, but is not limited to, a barcode tagging device or an RFID tagging device. It will be appreciated that the asset tag reader may be any type of device that is capable of reading information from an asset tag and that the asset tagging device is any type of device that is capable of creating an asset tag with information and/or updating an asset tag with new information.

In embodiments of the invention, the asset tagging device may include an input module that is operable by the human operator to input information for the asset tag of each packed stream of product or commodity. Non-limiting examples of the input module include a keyboard, a computer mouse and a touchscreen of an electronic device.

In further embodiments of the invention, the enclosure unit may include a hazardous waste receptacle for storing hazardous waste. This allows the human operator to safely isolate any hazardous waste without adversely affecting the speed and efficiency of the waste segregation process. The hazardous waste receptacle may be, but is not limited to, a bag, a bin, a package or a box.

In still further embodiments of the invention, the enclosure unit may include a plurality of storage receptacles. Each storage receptacle may be configured for storing a respective stream of product or commodity after segregation and before packing. The provision of the multiple storage receptacles enables the human operator to establish a clear separation between the various streams of product and commodity, thus avoiding the risk of cross-contamination between different streams. Each storage receptacle may be, but is not limited to, a bag, a bin, a package or a box.

The enclosure unit may include a cleaning device for cleaning one or more of the streams of product or commodity. The cleaning device may use water and/or a cleaning fluid such as detergent. The purpose of the cleaning device is to enable the human operator to wash and/or decontaminate one or more dirty or contaminated streams of product or commodity

The enclosure unit may include at least one waste processing device for processing one or more of the streams of product or commodity. This enables the human operator to carry out an on-site processing of the streams of product or commodity into a form that is suitable for packing, instead of having to transport the streams of product or commodity to another location with waste processing equipment. Non-limiting examples of the or each waste processing device include a compactor, a baler or a crusher.

Optionally the enclosure unit may include a storage facility for storing each packed stream of product or commodity. This provides a secure storage area for the packed streams of product or commodity prior to collection from the mobile waste segregation system. Furthermore, the provision of the asset tags on the packed streams of product or commodity avoids the risk of mix-up during the collection.

Further optionally the enclosure unit may include a weighing scale for weighing each stream of product or commodity. The weight information can be added to the asset tag of each packed stream of product or commodity.

In embodiments of the invention, the enclosure unit may include at least one hand-operated waste segregation tool for segregating the waste from the or each waste container into the different streams of product or commodity. This enables manual segregation of the waste to be carried out in a safe and reliable fashion.

In further embodiments of the invention, the mobile waste segregation system may include a lifting apparatus operable to lift the or each waste container into the enclosure unit. This is particularly useful for handling heavy or bulky waste containers.

In still further embodiments of the invention, the enclosure unit may include a personnel identification device operable to identify the human operator. The personnel identification device may be used in combination with a health and safety check to ensure that the human operator is capable of carrying out the waste segregation process.

According to a second aspect of the invention, there is provided a method of segregating waste using a mobile waste segregation system transportable between different sites, the mobile waste segregation system comprising an enclosure unit configured for housing a human operator, the method comprising the steps of:

transporting the mobile waste segregation system to a new site;

receiving one or more waste containers from the new site in a waste segregation facility in the enclosure unit;

reading an asset tag of the or each waste container;

segregating the waste from the or each waste container in the waste segregation facility, wherein the waste is segregated into different streams of product or commodity;

packing each stream of product or commodity in a packing facility of the enclosure unit;

adding an asset tag to each packed stream of product or commodity and/or updating an existing asset tag of each packed stream of product or commodity.

The features and advantages of the mobile waste segregation system of the first aspect of the invention and its embodiments apply mutatis mutandis to the features and advantages of the method of the second aspect of the invention and its embodiments.

The method may include the step of reading a barcode or RFID tag of the or each waste container, and/or the step of adding a barcode or RFID tag to each packed stream of product or commodity and/or updating an existing barcode or RFID tag of each packed stream of product or commodity.

The method may include the step of inputting information for the asset tag of each packed stream of product or commodity.

The method may include the step of storing hazardous waste in a hazardous waste receptacle in the enclosure unit.

The method may include the step of storing each stream of product or commodity in a respective one of a plurality of storage receptacles in the enclosure unit after segregation and before packing.

The method may include the step of cleaning one or more of the streams of product or commodity in the enclosure unit.

The method may include the step of processing one or more of the streams of product or commodity in the enclosure unit. Such processing may include the step of compacting, baling and/or crushing one or more of the streams of product or commodity in the enclosure unit.

The method may include the step of storing each packed stream of product or commodity in or on a storage facility in the enclosure unit and/or the step of weighing each stream of product or commodity in the enclosure unit.

The method may include the step of using at least one hand-operated waste segregation tool to segregate the waste from the or each waste container into the different streams of product or commodity in the enclosure unit.

The method may include the step of operating a lifting apparatus for lifting the or each waste container into the enclosure unit.

The method may include the step of operating a personnel identification device to identify the human operator prior to the human operator handling the waste.

It will be appreciated that the use of the terms “first” and “second”, and the like, in this patent specification is merely intended to help distinguish between similar features, and is not intended to indicate the relative importance of one feature over another feature, unless otherwise specified.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

A preferred embodiment of the invention will now be described, by way of a non-limiting example, with reference to the accompanying drawings in which:

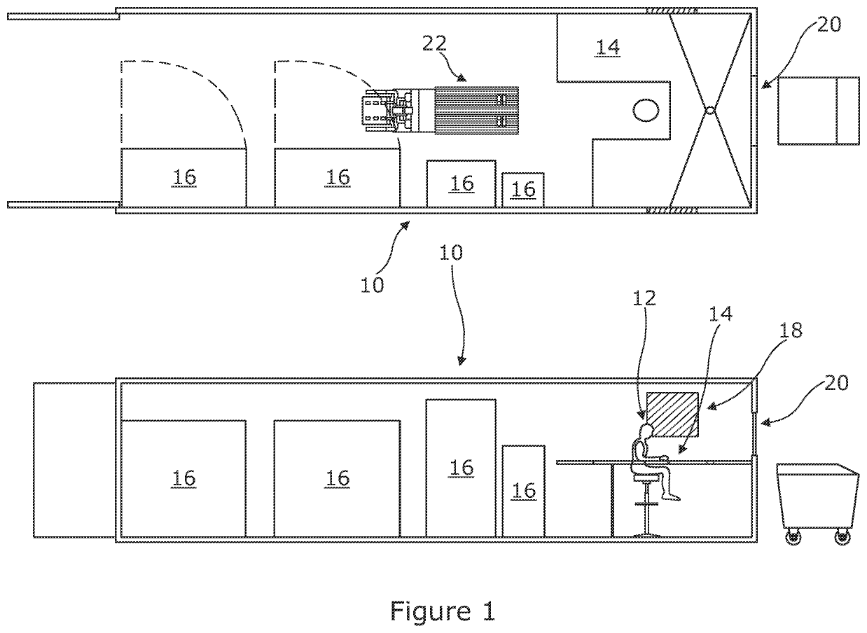

FIG. 1 shows a mobile waste segregation system according to an embodiment of the invention; and

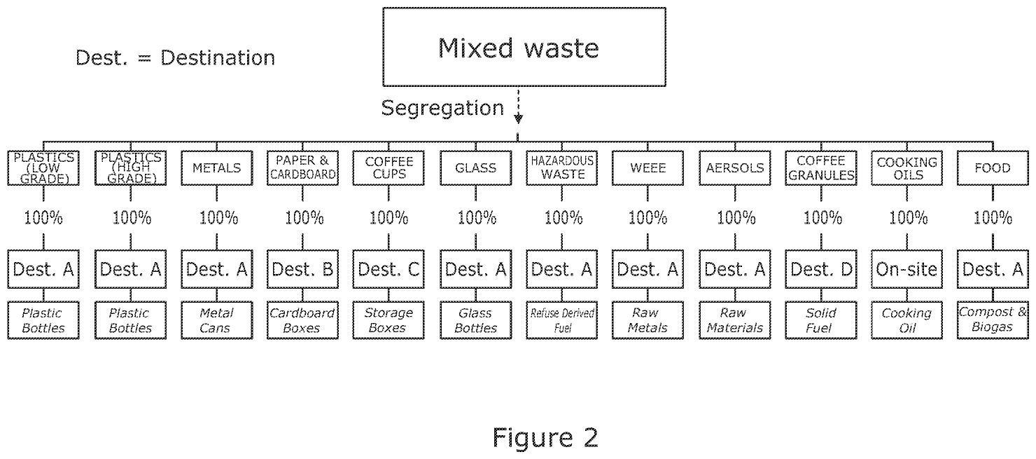

FIG. 2 illustrates a segregation of waste into multiple streams of product or commodity.

The figures are not necessarily to scale, and certain features and certain views of the figures may be shown exaggerated in scale or in schematic form in the interests of clarity and conciseness.

A mobile waste segregation system according to an embodiment of the invention is shown in FIG. 1. The mobile waste segregation system includes an enclosure unit 10 that is in the form of a cargo container that can be loaded onto a back of a lorry or other vehicle.

This enables the mobile waste segregation system to be transported between different sites.

The enclosure unit 10 is sized so that one or more human operators 12 can work freely inside the enclosure unit 10. The enclosure unit 10 houses a personnel identification device, a waste segregation facility 14, an RFID reader, a cleaning device, a plurality of storage containers, a plurality of waste processing devices 16, a packing facility, a weighing scale, an RFID tagging device and a storage facility. The enclosure unit 10 additionally includes a fire alarm system, a closed-circuit television camera system and an air ventilation system 18. In addition to the enclosure unit 10, the mobile waste segregation system includes a lifting apparatus.

Use of the mobile waste segregation system to carry out a waste segregation process is described as follows with reference to FIGS. 1 and 2.

Initially the mobile waste segregation system is transported to a new site. For the sake of illustrating how the invention works, the invention is described with reference to a train station as the new site, but it will be appreciated that the invention is applicable to other types of waste-producing sites, non-limiting examples of which are described elsewhere in this specification.

After the mobile waste segregation system is parked at the new site, a human operator (referred to hereon as a waste warden 12) is required to complete a pre-operational safety audit before carrying out the waste segregation process. The waste warden 12 stands in front of the personnel identification device, which includes a camera linked to a computer having a processor and a memory programmed with facial recognition software. Once the facial recognition software identifies the waste warden 12, the computer will walk the waste warden 12 through a series of questions and checks to carry out an assessment, which includes checking the physical and mental well-being of the waste warden 12, the waste warden's understanding of the risks and procedures of the waste segregation process and the waste warden's certification and equipment requirements.

After the waste warden 12 passes the assessment, the waste warden 12 initiates the waste segregation process. Preferably the waste segregation facility 14 includes printed guidance in the form of text and/or graphics that explains the waste segregation process.

Waste bags from various sources (e.g. retailers, platform bins, office bins) may be stored at the locations of the sources or stored at a central facility in the train station. The waste bags are moved from the source or the central facility to the mobile waste segregation system. Each waste bag is received by the waste warden 12 through an entrance 20 (e.g. window or door) of the enclosure unit 10 and placed onto the waste segregation facility 14 (such as a table, desk or workbench) next to the window. In case of heavy or bulky waste bags, the lifting apparatus is operated to lift the waste bags through the entrance 20. Alternatively another person outside the enclosure unit 10 may pass the waste bags to the waste warden 12 through the entrance 20.

The waste warden 12 uses a RFID scanner to read an RFID tag attached to a given waste bag. The RFID tag includes information about the waste bag, such as the source of the waste, the type of waste and the quantity of the waste. The read information is then recorded as waste data that is then stored on the computer and/or in a cloud-based computing network. The stored waste data may also include the time, date and location of the collection of the waste bags, which may be automatically generated or manually inputted. It will be appreciated that the RFID tag of each waste bag may be read outside the enclosure unit 10 and prior to the waste bags being received through the entrance 20 of the enclosure unit 10, e.g. when the waste bags are collected from the various sources or the central facility.

The waste warden 12 then opens a waste bag, using a cutter if necessary. Once the waste bag is opened, a visual check for any sharp or harmful objects is conducted. Any sharp or harmful object is removed and placed in a dedicated hazardous waste container. For safety purposes, the waste warden 12 is equipped with waste segregation hand-operated tools (e.g. a picker and tongs) and body protective clothing (e.g. goggles, gloves and aprons).

After removing the sharp or harmful objects, the waste warden 12 manually segregates the remaining waste from the waste bag into different streams of product or commodity, as exemplarily illustrated by FIG. 2. Non-limiting examples of products and commodities include low grade plastics, high grade plastics, metals, paper, cardboard, coffee cups, glass, hazardous waste, waste electrical and electronic equipment (WEEE), aerosols, coffee granules, cooking oils and food. The sharp or harmful objects may be classed under the stream of hazardous waste. During the manual segregation, the different streams of product or commodity are stored in respective storage containers so as to physically separate the different streams to avoid cross-contamination.

The cleaning device may take the form of a hose or showerhead connected to a water tap that, if necessary, can be used to wash and/or decontaminate one or more of the streams of product or commodity. A cleaning fluid, such as detergent, may also be used. The cleaning device may also be used to wash down the waste segregation facility 14 so that it is in good order for the next waste segregation process.

The plurality of waste processing devices 16 includes a compactor, a baler and a crusher for on-site processing one or more of the streams of product or commodity. The compactor is operated to compact a selected stream of product or commodity to reduce its size. The baler is operated to form the selected stream of product or commodity into a bale of a specific size and shape. The crusher is used to crush a selected stream of product or commodity, such as glass.

Where applicable, suitable segregated streams of product or commodity in the storage containers are emptied into corresponding compactors, balers and crushers, as necessary. Preferably the waste processing involves at least forming bales out of the segregated streams of product or commodity. Each bale may be packed and secured using a fastener, such as a rope tie and prong.

The bale is removed from the baler and placed onto a pallet 22 at which point the bale is weighed using the weighing scale and then electronically tagged with an RFID tag using the RFID tagging device. Preferably each bale is prepared to have a predetermined weight. The information in the RFID tag includes the type of product or commodity, time and date stamps, the weight of the product or commodity, the end destination of the product or commodity and optionally waste transfer documentation.

At this point each bale is now ready for transportation and is moved to a storage facility. Each bale may be packed inside a packing container, such as a bag, a bin, a package or a box. For example, a given bale may be securely locked down with a sealed plastic lid. The plastic sealed lid is a lightweight plastic “freight lid” and will cover the bale and the entire pallet so that no weathering or any pest can get underneath the pallet and into the waste. Optionally an RFID tag with the information about the bale may be added to each packing container, or an existing RFID tag of each packing container may be updated to include the information about the bale.

It will be appreciated that one or more packed streams of product or commodity, such as coffee granules, cooking oils and food, will have to be packed inside respective packing containers to which an RFID tag may be added or for which an existing RFID tag may be updated.

When the waste collector arrives to pick up the packed streams of product or commodity, they may optionally retrieve the waste transfer document from each RFID tag. The packed streams of product or commodity are then collected and transported to their respective end destinations for further usage or processing into usable products or commodities. In this way, each segregated stream of product or commodity is recyclable, diverting any need for the incineration to landfill procedure. It will be appreciated that different packed streams of product or commodity may be transported to different end destinations or the same end destination, multiple waste collectors may pick up different packed streams of product or commodity and/or one or more streams of product or commodity may be left on-site for further usage or processing into usable products or commodities.

The processing of the segregated streams of product or commodity, as necessary, into clean and tidy bales and packing containers with specific dimensions and weight not only makes it easier for the waste to be collected and handled by the waste collector but also enables the waste collectors to be cost and energy efficient by coming to collect the bales only when needed, thus saving time, energy, fuel and associated carbon credits that have air pollution reduction benefits.

The features of the mobile waste segregation system of the invention therefore enable the waste warden 12 to carry out the waste segregation process inside a safe, clean and contained environment that is smaller in size and footprint than a standard waste compactor used in conventional waste processing for recycling. Meanwhile the integration of asset tracking procedures into the waste segregation process together with the information in the asset tags of the waste bags and the packed bales enable the tracking of waste-related information to generate accurate quantitative and qualitative waste data.

The waste data can be used to improve the waste management systems of the train station to provide cost savings and improve compliance with environmental regulations. For example, the waste management systems may be enhanced by:
optimising the frequency of waste collection using the time, date and location information and the type and amount of waste generated by the train station;
tracking waste bag usage, such as identifying whether the waste bags are underutilised or overutilised, in order to optimise individual waste bag usage and optimise the number of waste bags required by each source;
tracking waste-producing behaviour of the site and each source, including breakdown by waste type and amount and by time and date;
tracking historical waste generation, contamination levels, recycling rates, recycling quality, carbon footprint and pollution figures.

The waste data can be presented immediately and/or via a regular schedule. For example, the waste data can be compiled and presented in real-time using an online dashboard system and/or can be communicated to the waste-producers at a later time, preferably at regular intervals, using e-mails, text messaging, mobile apps or other forms of electronic communication.

It is envisaged that, in other embodiments of the invention, the RFID tag, reader and tagging device may be replaced by other types of asset tags, asset readers and asset tagging devices, such as a barcode tag, a barcode reader and a barcode tagging device. The barcode tag may be a barcode label. The barcode tagging device may be configured to produce barcode labels.

It is envisaged that, in other embodiments of the invention, the function of the computer may be implemented by one or more of an electronic device, a portable electronic device, a portable telecommunications device, a mobile phone, a personal digital assistant, a tablet, a phablet, a desktop computer, a laptop computer, a server, a cloud computing network, a smartphone, a smartwatch, smart eyewear, and a module for one or more of the same.

It is envisaged that, in other embodiments of the invention, the camera may be replaced by a different type of image capture device.

It is envisaged that, in still other embodiments of the invention, information about the product or commodity may be inputted into the input module by using a keyboard, using a computer mouse, using a virtual keyboard on a touchscreen and/or choosing from a range of preset answers displayed on the touchscreen. Alternatively or additionally, the input module may be configured to read text, for example, by computer vision and/or optical character recognition.

It will be appreciated that references to a memory or a processor may encompass a plurality of memories or processors.

Preferences and options for a given aspect, feature or parameter of the invention should, unless the context indicates otherwise, be regarded as having been disclosed in combination with any and all preferences and options for all other aspects, features and parameters of the invention.

1. A mobile waste segregation system transportable between different sites, the mobile waste segregation system comprising:
an enclosure unit configured for housing a human operator, the enclosure unit including a waste segregation facility for receiving at least one waste container and segregating the waste from the or each waste container into different streams of product or commodity, the enclosure unit further including a packing facility operable to pack each stream of product or commodity;
an asset tag reader operable to read an asset tag of the or each waste container; and
an asset tagging device operable to add an asset tag to each packed stream of product or commodity and/or update an existing asset tag of each packed stream of product or commodity.

2. A mobile waste segregation system according to claim 1 wherein the asset tag reader is a barcode reader or an RFID reader, and/or the asset tagging device is a barcode tagging device or an RFID tagging device.

3. A mobile waste segregation system according to claim 1 of the preceding claims wherein the asset tagging device includes an input module that is operable by the human operator to input information for the asset tag of each packed stream of product or commodity.

4. A mobile waste segregation system according to claim 1 wherein the enclosure unit includes a hazardous waste receptacle for storing hazardous waste.

5. A mobile waste segregation system according to claim 1 wherein the enclosure unit includes a plurality of storage receptacles, each storage receptacle configured for storing a respective stream of product or commodity after segregation and before packing.

6. A mobile waste segregation system according to claim 1 wherein the enclosure unit includes a cleaning device for cleaning one or more of the streams of product or commodity.

7. A mobile waste segregation system according to claim 1 wherein the enclosure unit includes at least one waste processing device for processing one or more of the streams of product or commodity.

8. A mobile waste segregation system according to claim 7 wherein the or each waste processing device is a compactor, a baler or a crusher.

9. A mobile waste segregation system according to claim 1 wherein the enclosure unit includes a storage facility for storing each packed stream of product or commodity, and/or wherein the enclosure unit includes a weighing scale for weighing each stream of product or commodity.

10. (canceled)

11. A mobile waste segregation system according to claim 1 wherein the enclosure unit includes at least one hand-operated waste segregation tool for segregating the waste from the or each waste container into the different streams of product or commodity.

12. A mobile waste segregation system according to claim 1 including a lifting apparatus operable to lift the or each waste container into the enclosure unit.

13. A mobile waste segregation system according to claim 1 wherein the enclosure unit includes a personnel identification device operable to identify the human operator.

14. A method of segregating waste using a mobile waste segregation system transportable between different sites, the mobile waste segregation system comprising an enclosure unit configured for housing a human operator, the method comprising the steps of:
transporting the mobile waste segregation system to a new site;
receiving one or more waste containers from the new site in a waste segregation facility in the enclosure unit;
reading an asset tag of the or each waste container;
segregating the waste from the or each waste container in the waste segregation facility, wherein the waste is segregated into different streams of product or commodity;
packing each stream of product or commodity in a packing facility of the enclosure unit;
adding an asset tag to each packed stream of product or commodity and/or updating an existing asset tag of each packed stream of product or commodity.

15. A method according to claim 14 including the step of reading a barcode or RFID tag of the or each waste container, and/or the step of adding a barcode or RFID tag to each packed stream of product or commodity and/or updating an existing barcode or RFID tag of each packed stream of product or commodity.

16. A method according to claim 14 including the step of inputting information for the asset tag of each packed stream of product or commodity.

17. A method according to claim 14 including the step of storing hazardous waste in a hazardous waste receptacle in the enclosure unit.

18. A method according to claim 14 including the step of storing each stream of product or commodity in a respective one of a plurality of storage receptacles in the enclosure unit after segregation and before packing.

19. A method according to claim 14 including the step of cleaning one or more of the streams of product or commodity in the enclosure unit.

20. A method according to claim 14 including the step of processing one or more of the streams of product or commodity in the enclosure unit.

21. A method according to claim 20 including the step of compacting, baling and/or crushing one or more of the streams of product or commodity in the enclosure unit.

22.-25. (canceled)
